(19) United States
(12) Patent Application Publication
(10) Pub. No.: US 2016/0342927 A1
(43) Pub. Date: Nov. 24, 2016

(54) SYSTEMS AND METHODS FOR PROVIDING AN INFORMATION TECHNOLOGY INTERFACE

(71) Applicant: HEWLETT PACKARD ENTERPRISE DEVELOPMENT LP, Houston, TX (US)

(72) Inventors: Leonid Reznik, Yehud (IL); Ben Cohen, Yehud (IL); Gil Tzadikevitch, Yehud (IL); Aviad Cohen, Yehud (IL); Noa Danon, Yehud (IL); Arik Sityon, Yehud (IL)

(21) Appl. No.: 15/114,826

(22) PCT Filed: Mar. 28, 2014
(86) PCT No.: PCT/US2014/032257

§ 371 Date: Jul. 27, 2016

(51) Int. Cl. G06Q 10/06; G06F 3/0481; G06F 3/0484; H04L 12/58; G06Q 30/00

(52) U.S. Cl. CPC G06Q 10/063114; H04L 51/046; G06Q 30/016; G06F 3/04842; G06F 3/04812

(57) ABSTRACT

A system to provide an information technology (IT) interface. The system includes an IT ticket information engine to detect a user input action that indicates a selection of an IT ticket, or its associated stakeholder, that represents an IT services request and specifies one or more ticket stakeholders. The system also includes a display engine coupled to a display device, where the display engine is configured to, as a result of the IT ticket or stakeholder being selected by the user input action, cause the display device to display multiple contact options for one of the ticket stakeholders in the IT interface. The IT ticket information engine compiles the multiple contact options from one or more applications separate from the IT interface.

### BACKGROUND

A service ticket—or an information technology (IT) ticket—is created to track a technological problem requiring a solution. During the lifecycle of an IT ticket, many stakeholders may be involved in carrying out various tasks that must be completed to fulfill the requirements of the ticket. Identifying and contacting the relevant stakeholder for a given point in the IT ticket's lifecycle is both difficult and time consuming because of the need to navigate between multiple areas in an IT interface, investigate various history journals or communication logs, and search for contact details for that stakeholder.

### BRIEF DESCRIPTION OF THE DRAWINGS

For a detailed description of various examples of the invention, reference will now be made to the accompanying drawings in which:

FIG. 1 shows a diagram of an exemplary workflow for an IT ticket in accordance with various examples of the present disclosure;

FIGS. 2a-d show various examples of an information technology (IT) interface in accordance with various examples of the present disclosure;

FIG. 3 shows a block diagram of a system to provide an IT interface in accordance with various examples of the present disclosure;

FIG. 4 shows a block diagram of another example system to provide an IT interface in accordance with various examples of the present disclosure; and

FIGS. 5a-b show flow charts of a method for providing an IT interface in accordance with various examples of the present disclosure.

### DETAILED DESCRIPTION

Certain terms are used throughout the following description and claims to refer to particular system components. As one skilled in the art will appreciate, computer companies may refer to a component by different names. This document does not intend to distinguish between components that differ in name but not function, In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

As used herein, the term “ticket submitter” refers to a person or group who submits an information technology (IT) ticket.

As used herein, the term “ticket owner” refers to a person or group that is responsible for overseeing the progress of an IT ticket through its lifecycle and is responsible for the end result of the IT ticket.

As used herein, the term “stakeholder” refers to a person or group responsible for some aspect of IT ticket completion during a relevant time period. For example, when the IT ticket is in work, the stakeholder may be the party assigned to perform at least one task to complete the work required by the IT ticket.

To help solve some of the problems described above, in accordance with various examples of the present disclosure, an information technology (IT) interface is provided that enables straight-forward identification of a ticket stakeholder and access to communication with the ticket stakeholder. The identity of the ticket stakeholder may change based on the workflow phase that the IT ticket is in at the time that contact is desired. Further details and examples are discussed below where reference is made to the accompanying drawings.

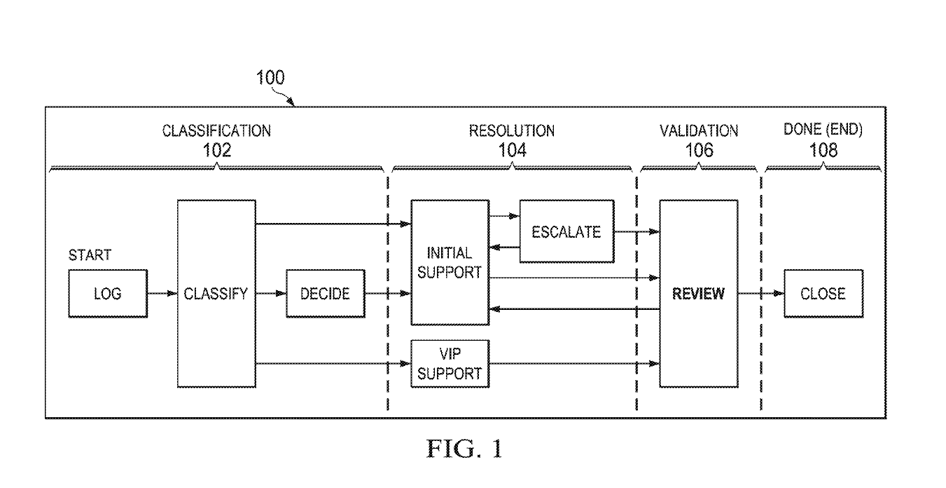

FIG. 1 shows an exemplary workflow 100 for an IT ticket in accordance with various examples of the present disclosure. As shown, the workflow 100 includes a classification phase 102, a resolution or fulfillment phase 104, a validation phase 106, and a closure phase 108. Other phases, sub-phases, or combinations of phases are within the scope of the present disclosure as well. For example, an approval phase may exist as a sub-phase to the classification phase 102. In short, the workflow 100 presents a methodology to identify where an IT ticket stands in a progression to completion of the ticket. The relevant stakeholder for an IT ticket may change based on where the ticket is (i.e., which phase) in its lifecycle. However, in some cases a ticket owner is a stakeholder in multiple or all phases of an IT ticket's lifecycle.

In the ticket classification phase 102, a ticket may be logged into an IT tracking application and parsed to determine a priority for the ticket and a proper ticket assignment destination. Additionally, during the classification phase 102, the ticket may be subject to an approval phase, where one or more parties approve the ticket to continue in the workflow 100. In the ticket resolution phase 104, tasks required for completion of the IT ticket are performed. In the validation phase 106, the tasks performed for completion of the IT ticket are reviewed for correctness, appropriateness, and to ensure that the requirements of the IT ticket have been satisfied. Finally, in the closure phase 108, the IT ticket may be archived for future access.

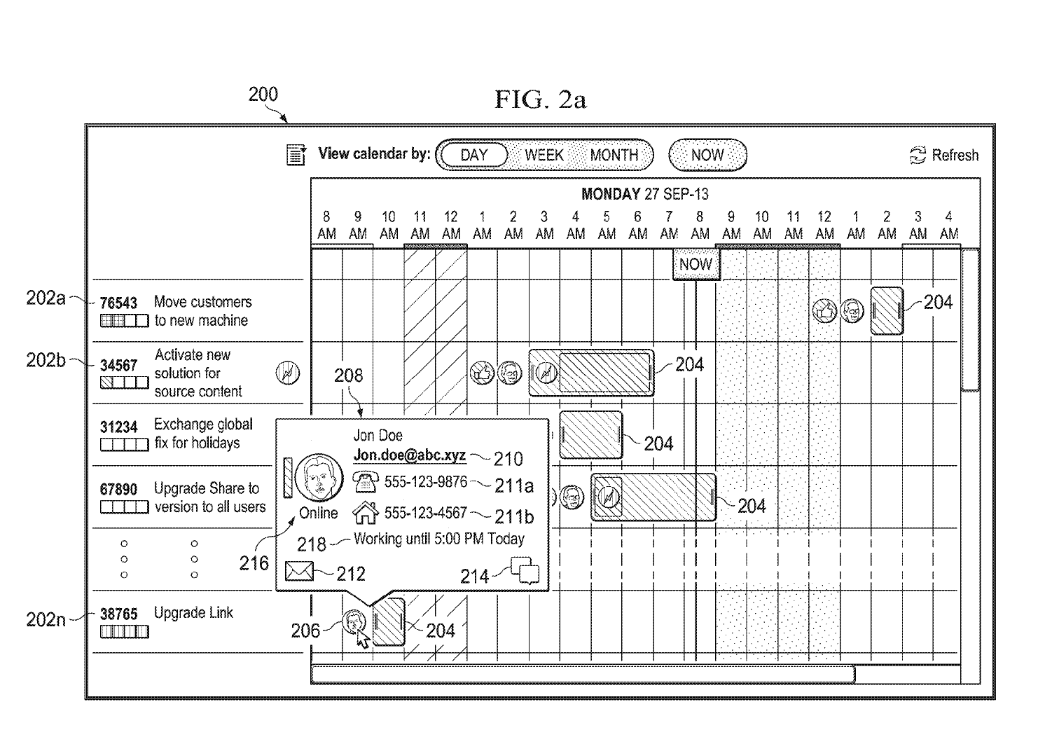

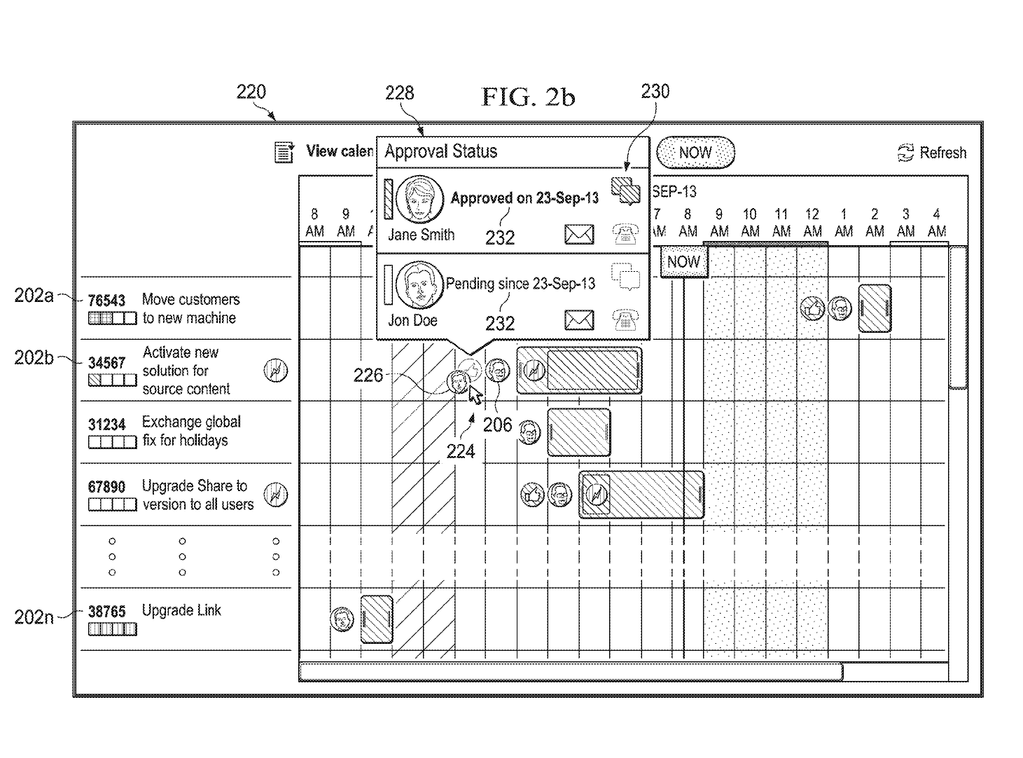

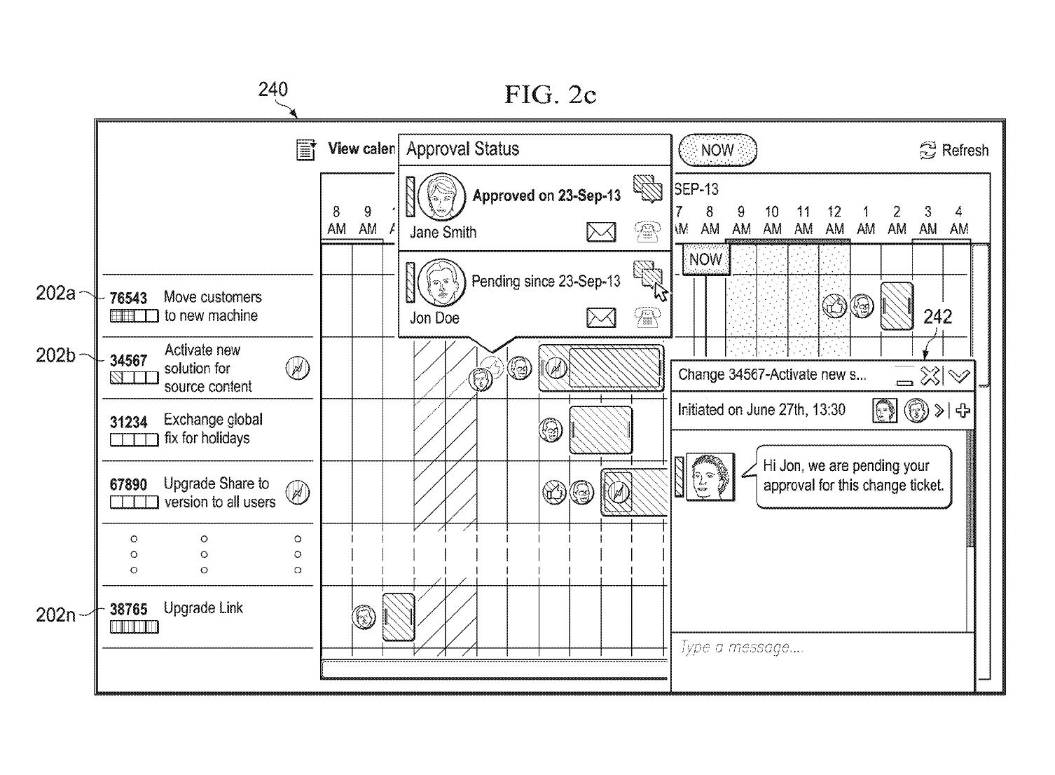

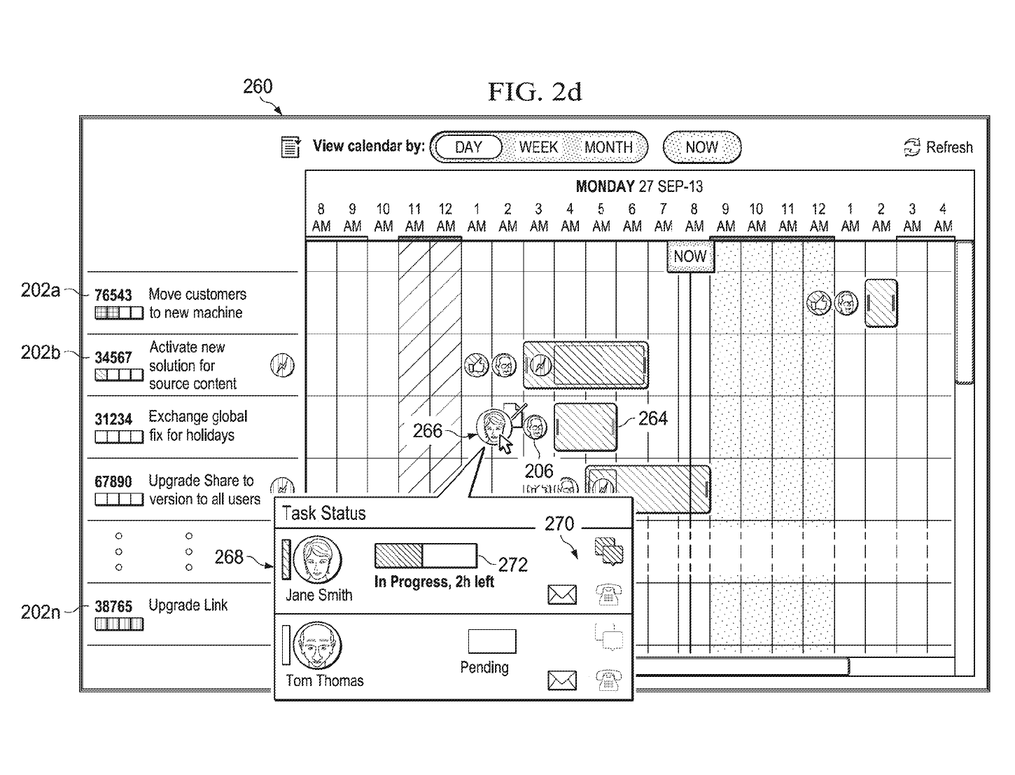

Turning now to FIGS. 2a-d, various examples of an IT interface are shown in accordance with various examples of the present disclosure. Each example represents a possible view of the IT interface at a different point in time in an IT ticket's progression to completion. FIG. 2a shows one such example of an IT interface 200. The IT interface 200 is shown in a calendar type view (e.g., a Gantt chart) where each row 202a-n represents an IT ticket that has been submitted by a ticket submitter. Each IT ticket may be assigned an informal and descriptive name, such as “upgrade software to most recent version.” The IT tickets 202a-n are represented by bars 204, which span a number of columns on the Gantt chart based on the time that the IT ticket 202a-n is scheduled to be in work.

In order to simplify identification of a ticket owner for a given IT ticket 202a-n, an icon 206 representing the ticket owner is displayed in the IT interface 200 adjacent or near to the bar 204 that represents the time period that the IT ticket 202a-n is scheduled to be in work. By directly associating the ticket owner with their respective IT ticket 202a-n within the single IT interface 200, a user of the IT interface 200 spends less time determining the appropriate owner for an IT ticket 202a-n.

Further, in accordance with various examples of the present disclosure, when a user input action selects the ticket owner represented by the icon 206, the IT interface 200 displays a pop-up box 208 that contains multiple contact options for the ticket owner. The user input action may include hovering a mouse cursor over the icon 206, clicking on the icon 206, or the like. The contact options may include an email address 210 and phone numbers 211a-b (e.g., an office phone number and a mobile phone number). The contact options may also include a button 212 to send an email or a button 214 to send an instant message. The pop-up box 208 may also indicate whether the ticket owner is available for instant messaging through the use of an indicator 216 of whether the ticket owner is online, available, or the like and may indicate a work schedule for the ticket owner. The information for the ticket owner—or any ticket stakeholder—may be integrated by the IT interface 200 from other applications such as scheduling applications, contact storage applications, and the like.

Thus, in the event that a user of the IT interface 200 desires to contact the ticket owner, the user is able to do so from a single application, rather than being forced to navigate between multiple views or pages in an IT interface or investigate various history journals or communication logs for the IT ticket to identify the ticket owner, then subsequently search for contact details for the ticket owner, and access the appropriate communication application to initiate communication with the ticket owner using the ascertained contact details.

FIG. 2b shows another such example of an IT interface 220. As above, the IT interface 220 is shown in a calendar type view (e.g., a Gantt chart) where each row 202a-n represents an IT ticket that has been submitted by a ticket submitter. In this example, the IT interface 220 represents a view that corresponds with a bar 224 representing an IT ticket 202a-n being in the approval phase. When an IT ticket 202a-n is in the approval phase, rather than (or in addition to, as pictured) displaying an icon representing the ticket owner adjacent or near the bar 224, one or more icons representing parties whose approval is required to approve the IT ticket 202a-n are displayed adjacent or near to the bar 224. By directly associating the parties whose approval is required to approve the IT ticket 202a-n with their respective IT ticket 202a-n within the single IT interface 220, a user of the IT interface 220 spends less time determining the parties whose approval is required to approve the IT ticket 202a-n.

Similar to FIG. 2a, when a user input action selects the parties whose approval is needed represented by the icon 226, the IT interface 220 displays a pop-up box 228 that contains various contact options 230 for the parties as well as an approval status 232 for each party. The approval status 232 may indicate whether the party has approved and, if so, at what time. The pop-up box 228 may also indicate whether the party is available for instant messaging and, although not shown, may include further details for the parties as shown in the pop-up box 208 of the ticket owner in FIG. 2a. Also, while not required, the icon 206 for the ticket owner may be shown adjacent or near the bar 224 in all some or all phases of the IT ticket 202a-n.

Thus, in the event that a user of the IT interface 220 desires to contact the parties responsible for approving the IT ticket 202a-n, they are able to do so from a single application, rather than being forced to navigate between multiple views or pages in an IT interface or investigate various history journals or communication logs for the IT ticket to identify the parties responsible for approval, then subsequently search for contact details for one or each party, and access the appropriate communication application to initiate communication with those parties using the ascertained contact details.

FIG. 2c shows another such example of an IT interface 240. The pictured IT interface 240 is similar to the IT interface 220 shown in FIG. 2b, except that an instant message box 242 is shown, which indicates that the user of the IT interface 240 has initiated a conversation with one of the parties whose approval is needed for an IT ticket 202a-n. The example shown in FIG. 2c demonstrates the ease with which a user is able to contact the relevant stakeholder for an IT ticket 202a-n at a given time in its lifecycle. In this example, the user has elected to contact the party who has not yet approved an IT ticket 202a-n to remind that party that their approval is still needed. The communication—in this case an instant message 242—is initiated from a single IT interface 240 and without the need to access other applications such as a contact storage application, a messaging application, an email application, and the like. As described above, the instant message 242 or other communication may be initiated by, for example, clicking on an icon representing the desired type of communication, such as an instant message icon or an email icon. In this way, the IT interface 240 provides an embedded live conversation portal, including the status of the various stakeholders. In certain examples, when a user initiates such contact with a stakeholder, a subject field in the direct messaging interface is auto-populated with information associated with the particular IT ticket 202a-n, such as a ticket number, a ticket subject, or the like.

FIG. 2d shows a further example of an IT interface 260. As above, the IT interface 260 is shown in a calendar type view (e.g., a Gantt chart) where each row 202a-n represents an IT ticket that has been submitted by a ticket submitter. In this example, the IT interface 260 represents a view that corresponds with a bar 264 representing an IT ticket 202a-n being in the execution or fulfillment phase. When an IT ticket 202a-n is in the fulfillment phase, rather than (or in addition to, as pictured) displaying an icon representing the ticket owner adjacent or near the bar 264, one or more icons representing parties having an assigned task for the IT ticket 202a-n are displayed adjacent or near to the bar 264. By directly associating the parties having tasks to perform to further completion of the IT ticket 202a-n with their respective IT ticket 202a-n within the single IT interface 260, a user of the IT interface 260 spends less time determining the parties required to work on the IT ticket 202a-n.

Similar to FIGS. 2a-c, when a user input action selects the parties having tasks to perform represented by the icon 266, the IT interface 260 displays a pop-up box 268 that contains various contact options 270 for the parties as well as a work status 272 for each party. The work status 272 may indicate whether the party has completed their task and, if not, what percentage or duration remains until completion. The pop-up box 268 may also indicate whether the party is available for instant messaging and, although not shown, may include further details for the parties as shown in the pop-up box 208 of the ticket owner in FIG. 2a.

Thus, in the event that a user of the IT interface 260 desires to contact the parties responsible performing tasks on the IT ticket 202a-n, they are able to do so from a single application, rather than being forced to navigate between multiple views or pages in an IT interface or investigate various history journals or communication logs for the IT ticket to identify the parties responsible working on the IT ticket 202a-n, then subsequently search for contact details for one or each party, and access the appropriate communication application to initiate communication with those parties using the ascertained contact details.

Further and similar to FIGS. 2a-d, icons for other ticket stakeholders may be shown at varying points in the IT ticket 202a-n lifecycle. For example, during the classification phase and optionally before the approval phase, the IT interface may display an icon for the ticket submitter that, when indicated by a user input action, causes the interface to display multiple contact options to enable IT personnel to contact the ticket submitter in the ways described above. Likewise, during the validation phase, the IT interface may display an icon for one or more parties required to review the completion of the IT ticket that, when indicated by a user input action, causes the interface to display multiple contact options to enable a user to contact the validating or reviewing party in the ways described above.

Additionally, in certain examples, the various pop-up windows described above may include an icon that allows a user of the IT interface to create a task or action item for a particular stakeholder. As a result of receiving an input indicating that the user desires to create a task for a stakeholder, the IT interface assigns that task to the identified stakeholder. In alternate examples, rather than clicking or hovering over an icon to indicate the desire to create a task for a stakeholder, the user may use an alternate input action such as right-clicking a mouse on a stakeholder's pop-up window, or other similar actions.

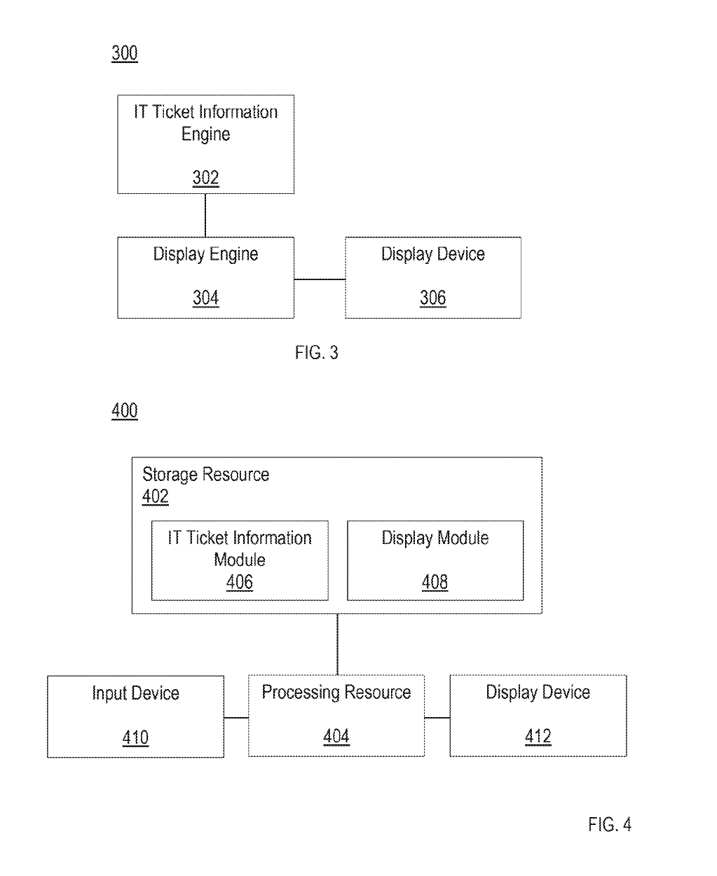

Turning now to FIG. 3, a system 300 to provide an IT interface is shown. As shown, the system 300 includes an IT ticket engine 302 and a display engine 304. The display engine 304 is coupled to a display device 306 and generally controls the content displayed on the display device 306. The IT ticket information engine 302 and the display engine 304 are combinations of programming and hardware to execute the programming. Although shown separately, the IT ticket information engine 302 and the display engine 304 are not required to represent separate pieces of software programming. For example, each engine 302, 304 may share a common processor and memory, although this is not required. Additionally, the programming that enables the functionality of each engine 302, 304 may be included in the same executable file or library.

The IT ticket information engine 302 detects a user input action that indicates a selection of an IT ticket 202a-n. As explained above, those IT tickets 202a-n represent IT services requests and each has one or more associated ticket stakeholders, In some cases the user input action may be hovering over or clicking on an icon representing the IT ticket 202a-n, one of the associated stakeholders, or a group of associated stakeholders.

As a result of one of the IT tickets 202a-n being selected by a user input action, the display engine 304 causes the display device to display multiple contact options for at least one of the stakeholders for the selected IT ticket 202a-n. As explained above, the contact options may include email addresses, telephone numbers, an instant message portal, and the like. In some cases, the display engine 304 also displays an indication of whether the stakeholder is available for direct messaging, a work schedule of the stakeholder, or other scheduling details associated with the stakeholder.

Based on the displayed contact options, the IT ticket information 302 engine may detect a user input action that indicates the user has selected one of the contact options, for example instant messaging. Subsequently, the IT ticket information engine 302 initiates contact with the stakeholder using an instant messaging interface. In some cases, the IT ticket information engine 302 auto-populates a subject field of a messaging interface, such as instant messaging or an email message, with information associated with the selected IT ticket. For example, such information could include a ticket number, a brief summary, or other such identifying information. In other cases, the IT ticket information engine 302 detects a user input action that indicates the user desires to create a task item for one of the stakeholders and, as a result of receiving such an input action, assigns the specified task to the identified stakeholder. The user input action may include clicking on or hovering over an icon to assign a task, or may be an alternate input action such as a right-click with a mouse or other similar device.

In the event that a user of the system 300 desires to contact an IT ticket stakeholder, they are able to do so from a single application. The system 300 thus provides a simplified interface rather than forcing the user to navigate between multiple views or pages in an IT interface or investigate various history journals or communication logs for the IT ticket to identify the stakeholder, then subsequently search for contact details for the stakeholder, and access the appropriate communication application to initiate communication with the stakeholder using the ascertained contact details.

FIG. 4 shows another example of a system 400 to provide an IT interface. The system 400 includes a storage resource 402 coupled to a processing resource 404. The processing resource 404 may be a single processor, a group of distributed processor, a single computer, or a plurality of computers. The storage resource 402 includes one or more local or distributed volatile storage devices (e.g., RAM) and/or non-volatile storage devices (e.g., HDD, flash storage, etc.) and comprises an IT ticket information module 406 and a display module 408. Thus, the storage resource 402 and the processing resource 404 are hardware components of the system 400. The system 400 also includes an input device 410 (e.g., a mouse, track ball, touch pad, etc.) and a display device 412 (e.g., a computer monitor) coupled to the processing resource 404.

Each module 406, 408 represents instructions that, when executed by the processing resource 404, implements an associated engine. For example, when the IT ticket information module 406 is executed by the processing resource 404, the above-described IT ticket information engine 302 functionality is implemented. Similarly, when the display module 408 is executed by the processing resource 404, the above-described display engine 304 functionality is implemented. The modules 406, 408 may also be implemented as an installation package or packages stored on the storage resource 402, which may be a CD/DVD or a server from which the installation package may be downloaded.

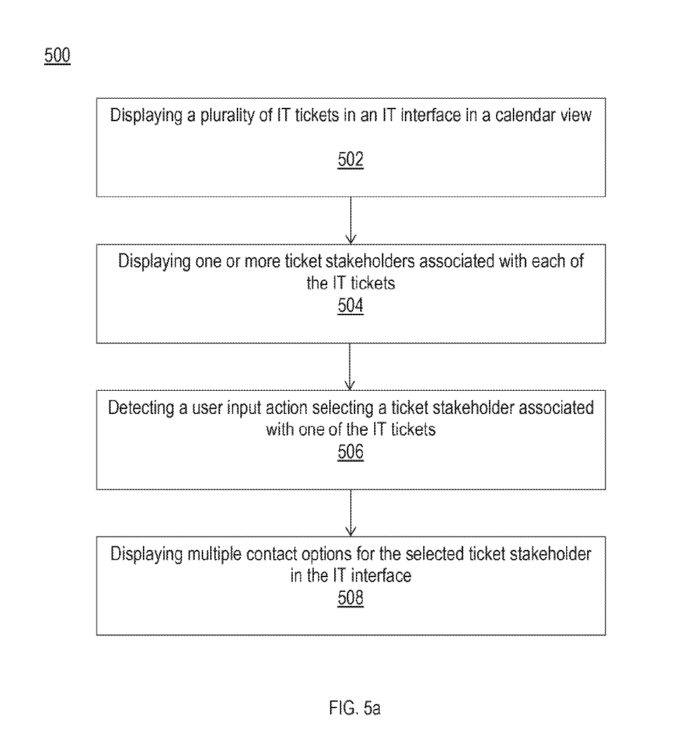

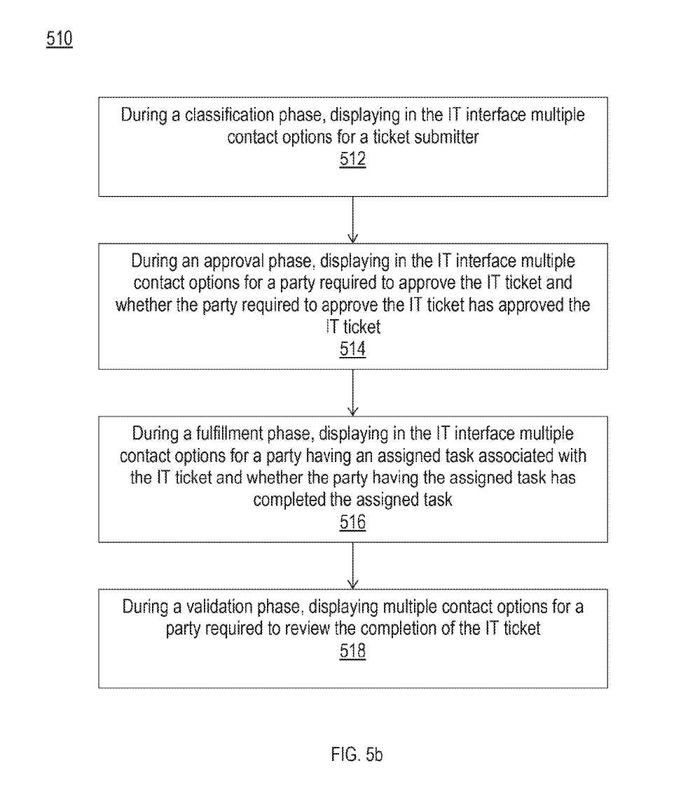

Turning now to FIG. 5a, a method 500 for providing an IT interface is shown. The method 500 begins in block 502 with displaying a plurality of IT tickets in the IT interface in a calendar view, for example by the display engine 304 coupled to the display device 306 or processing resource 404 coupled to the display device 412. As explained above, in some cases the calendar view appears as a Gantt chart, and an IT ticket may be displayed as a bar on the Gantt chart representing a start time and duration for the IT ticket. The method 500 continues in block 504 with displaying one or more ticket stakeholders associated with each of the IT tickets, for example by the display engine 304 coupled to the display device 306 or processing resource 404 coupled to the display device 412. The ticket stakeholders may include a ticket submitter, a ticket owner, a party whose approval is required to approve the IT ticket, a party who is assigned one or more tasks to complete the IT ticket, or a party who reviews the IT ticket after it is complete. A particular stakeholder may be displayed based on the current lifecycle phase of the IT ticket and may be, for example, shown as an icon including that stakeholder's picture.

The method 500 then continues in block 506 with detecting a user input action selecting a ticket stakeholder associated with one of the IT tickets, for example by the IT ticket information engine 302 or processing resource 404, and in block 508 with displaying multiple contact options for the selected ticket stakeholder in the IT interface, for example by the display engine 304 coupled to the display device 306 or processing resource 404 coupled to the display device 412. The user input action may be an action such as hovering over or clicking on the icon of the desired stakeholder, which causes a pop-up window to appear that contains the multiple contact options. In addition to contact options, a work schedule for the stakeholder, an indication of current availability for the stakeholder, an indication of the stakeholder's approval or amount of work completed, or other similar status may also be displayed. This allows a user to contact a relevant stakeholder for a given IT ticket at a given time from a single interface. Further, the method 500 avoids the need to navigate between multiple views or pages in an IT interface or investigate various history journals or communication logs for the IT ticket to identify the stakeholder, then subsequently search for contact details for the stakeholder, and access the appropriate communication application to initiate communication with the stakeholder using the ascertained contact details.

FIG. 5b shows a method 510 which may be, in certain cases, carried out in addition the method 500 of FIG. 5a. The method 510 relates generally to the functionality of an IT interface in various phases of an IT ticket lifecycle. For example, the method 510 begins in block 512 with displaying in the IT interface multiple contact options for a ticket submitter during the IT ticket classification phase, for example by the display engine 304 coupled to the display device 306 or processing resource 404 coupled to the display device 412. In the IT ticket approval phase, the method 510 continues in block 514 with displaying in the IT interface multiple contact options for a party required to approve the IT ticket and whether the party required to approve the IT ticket has approved the IT ticket, for example by the display engine 304 coupled to the display device 306 or processing resource 404 coupled to the display device 412.

In the IT ticket fulfillment phase, the method 510 continues in block 516 with displaying in the IT interface multiple contact options for a party having an assigned task associated with the IT ticket and whether the party having the assigned task has completed the assigned task. In some cases, if the party has not completed the assigned task, a percentage completion or remaining duration for completion may also be displayed. In the IT ticket validation phase, the method 510 includes displaying multiple contact options for a party required to review the completion of the IT ticket, as shown in block 518. Both blocks 516 and 518 may also be carried out, for example, by the display engine 304 coupled to the display device 306 or processing resource 404 coupled to the display device 412.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

What is claimed is:

1. A system to provide an information technology (IT) interface, the system comprising:
an IT ticket information engine, configured to detect a user input action that indicates a selection of an IT ticket that represents an IT services request and specifies one or more ticket stakeholders; and
a display engine coupled to a display device, the display engine configured to, as a result of the IT ticket being selected by the user input action, cause the display device to display multiple contact options for one of the ticket stakeholders in the IT interface;
wherein the IT ticket information engine compiles the multiple contact options from one or more applications separate from the IT interface.

2. The system of claim 1 wherein the IT ticket information engine is further configured to:
detect a user input action that indicates a selection of one of the contact options; and
initiate contact with the stakeholder using the selected contact option.

3. The system of claim 1 wherein the contact options comprise one or more e-mail addresses, one or more phone numbers, or a direct messaging option.

4. The system of claim 3 wherein the display engine is further configured to cause the display device to display whether the stakeholder is available for direct messaging.

5. The system of claim 3 wherein the IT ticket information engine is further configured to:
detect a user input action to initiate contact using direct messaging; and
auto-populate a subject field of a direct messaging interface with information associated with the selected IT ticket.

6. The system of claim 1 wherein the display engine is further configured to, as a result of the IT ticket being selected by a user input action, cause the display device to display a work schedule for the stakeholder.

7. The system of claim 1 wherein the IT ticket information engine is further configured to:
detect a user input action to create a task item for one of the stakeholders; and
assign the task item to the one of the stakeholders.

8. A method for providing an information technology (IT) interface, the method comprising:
displaying, by a processing resource coupled to a display device, a plurality of IT tickets, each representing an IT services request, in the IT interface in a calendar view;
displaying, by the processing resource, one or more ticket stakeholders associated with each of the IT tickets;
detecting, by the processing resource, a user input action selecting a ticket stakeholder associated with one of the IT tickets; and
as a result of the ticket stakeholder being selected by the user input action, displaying, by the processing resource, multiple contact options for the ticket stakeholder in the IT interface;
wherein the user input action comprises hovering a cursor over an icon representing the ticket stakeholder or clicking on the icon representing the ticket stakeholder; and
wherein the multiple contact options are compiled from one or more applications separate from the IT interface and comprise one or more e-mail addresses, one or more phone numbers, or a direct messaging option.

9. The method of claim 8 wherein:
the IT ticket is associated with a classification phase, an approval phase, a fulfillment phase, and a validation phase; and
the ticket stakeholders comprise at least one of a ticket submitter, a ticket owner, a party required to approve the IT ticket, a party having an assigned task associated with the IT ticket, and a party required to review the completion of the IT ticket;
the method further comprising:
during the classification phase, displaying in the IT interface multiple contact options for the ticket submitter;
during the approval phase, displaying in the IT interface multiple contact options for the party required to approve the IT ticket and whether the party required to approve the IT ticket has approved the IT ticket;
during the fulfillment phase, displaying in the IT interface multiple contact options for the party having an assigned task associated with the IT ticket and whether the party having the assigned task has completed the assigned task; and
during the validation phase, displaying in the IT interface multiple contact options for the party required to review the completion of the IT ticket.

10. A non-transitory computer-readable medium containing instructions that, when executed by a processing resource, cause the processing resource to:
detect a user input action that indicates a selection, within an information technology (IT) interface, of an IT ticket that represents an IT services request and specifies one or more ticket stakeholders; and
as a result of the IT ticket being selected by the user input action, cause a display device to display multiple contact options for one of the ticket stakeholders in the IT interface;
wherein the processing resource compiles the multiple contact options from one or more applications separate from the IT interface.

11. The non-transitory computer-readable medium of claim 10 wherein the instructions, when executed by the processing resource, further cause the processing resource to:
detect a user input action that indicates a selection of one of the contact options; and
initiate contact with the stakeholder using the selected contact option.

12. The non-transitory computer-readable medium of claim 10 wherein the contact options comprise one or more e-mail addresses, one or more phone numbers, or a direct messaging option, and wherein the instructions, when executed by the processing resource, further cause the processing resource to cause the display device to display whether the stakeholder is available for direct messaging.

13. The non-transitory computer-readable medium of claim 10 wherein the contact options comprise one or more e-mail addresses, one or more phone numbers, or a direct messaging option, and wherein the instructions, when executed by the processing resource, further cause the processing resource to;
detect a user input action to initiate contact using direct messaging; and
auto-populate a subject field of a direct messaging interface with information associated with the selected IT ticket.

14. The non-transitory computer-readable medium of claim 10 wherein the instructions, when executed by the processing resource, further cause the processing resource to, as a result of the IT ticket being selected by a user input action, cause the display device to display a work schedule for the stakeholder.

15. The non-transitory computer-readable medium of claim 10 wherein the instructions, when executed by the processing resource, further cause the processing resource to:
detect a user input action to create a task item for one of the stakeholders; and
assign the task item to the one of the stakeholders.
